(19) United States
(12) Patent Application Publication
(10) Pub. No.: US 2005/0187000 A1
(43) Pub. Date: Aug. 25, 2005

(54) Method for wagering

(75) Inventor: Kenneth L. Miller, Ankeny, IA (US)

Correspondence Address: BAKER BOTTS L.L.P., 2001 ROSS AVENUE, SUITE 600, DALLAS, TX, 75201-2980, US

(73) Assignee: Cantor Index LLC, New York, NY (US)

(21) Appl. No.: 10/784,353

(22) Filed: Feb. 23, 2004

(51) Int. Cl. A63F 13/00

(52) U.S. Cl. 463/6

(57) ABSTRACT

A new and unique method of gambling on horse races uses a predetermined number of races for the game. Preferably, the number of races in the game is significantly lower than the number of races in the racing event. The player then selects which races in the event to use for the game, selects which horses the player believes will win his selected races and places a bet on those horses. The races that the player uses for the game are not determined by the racetrack operators and need not be in consecutive order. Therefore, the player can play again if his selected winner loses. The player may continue to play the game so long as there are equal to or more than the predetermined number of races remaining. Winning players can be paid in a variety of ways and payments can be broken down to pay players whose selections all won and players whose selection did not all win.

### BACKGROUND OF THE INVENTION

Field of the Invention

The present invention relates to gambling. More specifically, the present invention relates to a new and unique way for players to enjoy gambling on pari-mutuel races. While there are many types of pari-mutuel races, i.e. greyhound, horse, etc., it is preferred that the present invention relate to gambling on horse races.

Gambling on horse races is a pastime whose exact beginning is unknown. For many ages, players have placed wagers on which horse would win, which horse would place or which horse would show. This bet, whether a horse will come in first, second or third is the simplest and most common form of horse race betting today.

Over the years, many other wagers have been developed to enhance the players gambling experience. For example, there are wagers known commonly as exotic wagers. These include the Exacta, where the player selects two horses to finish first and second in exact order. The Trifecta varies this theme a bit and requires a player to select the three horses to finish first, second and third in exact order. While this may seem like a difficult task, the payoffs can be large.

Other wagers have allowed a player to bet on several races with a single bet. Such games are usually known as a Pick(n) wager, with the number of races (n) involved indicated, such as a Pick 3 or Pick 4. The races that make up the Pick 4, for example, are four consecutive races chosen by the racetrack operators and may be listed on a racing ticket as the Pick 4 races. To win, the player must select the winner of each of the four races. The larger a Pick(n) size (i.e. a Pick 6 vs. a Pick 3), the lower the probability of a player correctly selecting all of the wager's winners. Consequently the prize money can be extremely rewarding.

While these wagers increase a player's possible return on investment, the probability of many players correctly selecting all of the winners of the designated races is small. To increase their chances, players can wager on more than one horse to win a race, for an additional amount of money per horse. Because current wagers restrict the races that are the subject of the Pick 4, a player who loses the first race would know they will not have any chance to win the prize money.

When experienced players do pick a horse, it is usually after researching the horse's racing background, jockey and related statistics. This information is provided in past performances through many different venues. A player may want to bet on certain races because the information/past performance indicates the player's potential return on investment are best for those races. However, often the races with what the player believes to be his best potential return on investment are not a part of a Pick 4 race pool. This situation often discourages players from even participating in the Pick 4. It is therefore desirable for a player to be able to make educated bets on the races of his choice, thereby increasing the player's comfort level and the likelihood the player will participate in the game. This also should increase the player's chances of winning and overall gaming experience.

There is therefore a need for a new and unique method of gambling on races which solves these and other problems.

### FEATURES OF THE INVENTION

A general feature of the present invention is the provision of a new and unique way for players to enjoy gambling on races which overcomes the problems found in the prior art.

A further feature of the present invention is the provision of a new and unique way for players to enjoy gambling on races which allows players to select the races for the Pick(n) pool on which to gamble.

A still further feature of the present invention is the provision of a new and unique way for players to enjoy gambling on races on Pick(n) tickets which allow a player to participate in as many of the event's races as possible.

These, as well as other features and advantages of the present invention, will become apparent from the following specification and claims.

### SUMMARY OF THE INVENTION

The present invention generally comprises a new and unique way for players to enjoy gambling on races, particularly pari-mutuel type races. More specifically, the present invention is a wager in which a player must select the winners of several races. The number of races in the wager is controlled by the racetrack operating authority, but the races used for the wager are selected by each individual player. Preferably, the present invention allows a player to select the winner of five races in a racing event, but the number of races used should always be less than the number of races in the racing event. The races the player selects do not have to be consecutive. After the races have been selected, the player places the wager, preferably a minimum of one dollar, with a teller or automated machine at the racetrack.

According to another feature of the present invention, a computer assisted method for administering betting on a number or plurality of races within a racing event allows a track to publish the racing event to a plurality of players. The players select which races to include in their wager and give their selection to the computer assisted wager operator. This can be done orally or through the use of a game card. The data on a game card would be transferred into a computer system. The players also give the operator the amount of money associated with their selection. The money is pooled, results are received and winners are identified. After the winners have been identified, the money is disbursed to the winners.

The present invention allows a player to select the races the player is most comfortable with, participate in the wager even if the player missed the first race, and play the wager again, even if losing the first few races in an event. After the event's races are concluded, the players who have correctly selected the number of required winners will divide all of the prize money.

### BRIEF DESCRIPTION OF THE DRAWINGS

FIG. 1 is a flow chart diagram of a preferred embodiment of the present invention.

FIG. 2 is a diagram of a wager card.

FIG. 3 is a schematic diagram of a typical race track wager.

### DETAILED DESCRIPTION OF THE PREFERRED EMBODIMENT

The present invention will be described as it applies to its preferred embodiment. It is not intended that the present invention be limited to the described embodiment. It is intended that the invention cover all modifications and alternatives which may be included within the spirit and scope of the invention.

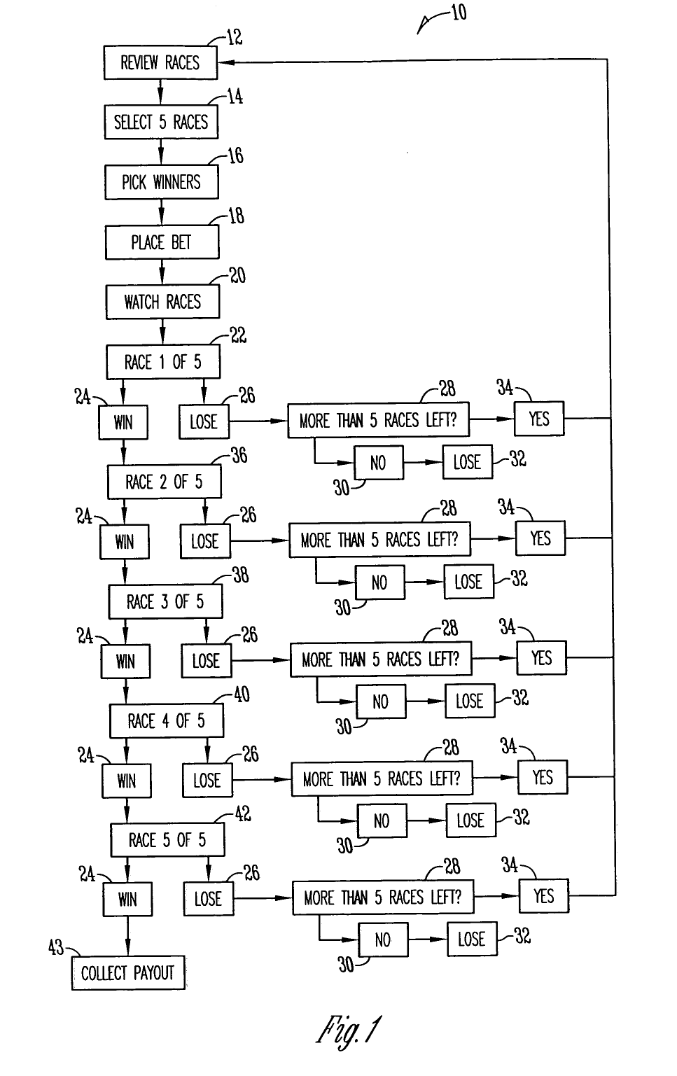

Referring to FIG. 1, the present invention is a new and unique method of gaming 10 in which the player is allowed to select the races on which to include in a Pick(n) style bet. Pick(n) style betting can be established for any number of races, but for simplicity purposes herein, a Pick 5 game shall be used.

The Pick 5 game 10 the present invention allows a player to review the races 12 of a racing event and select any five races 14. For example, if an event has ten races, the player may choose to use races 1, 4, 5, 7, and 10 as the races for his Pick 5 game. After the player has selected the five races 14, he must pick the winners 16 of each of those five races. A player may indicate a single horse or multiple horses for each race.

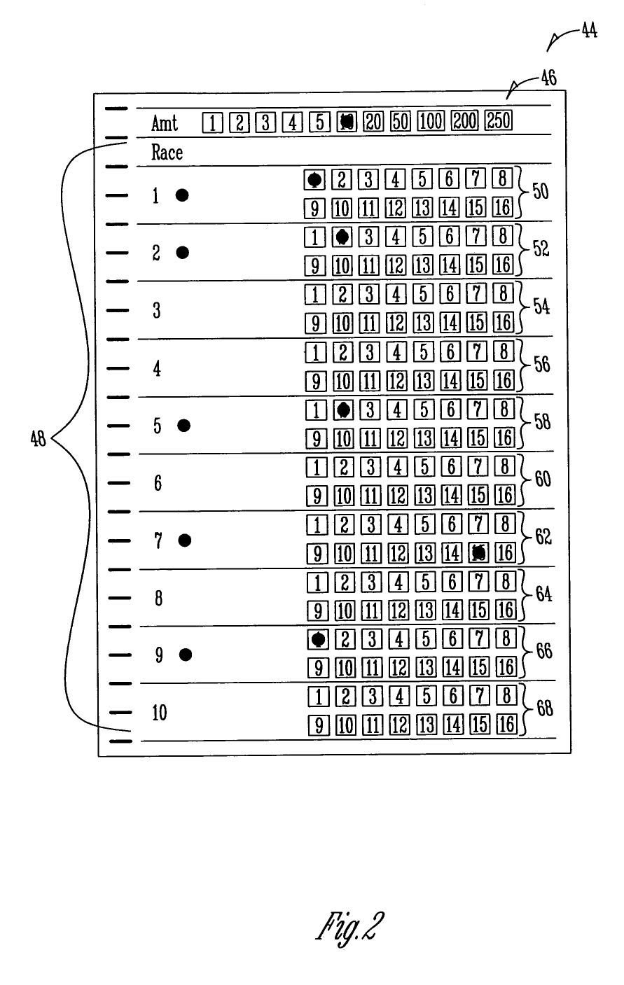

Once the player has chosen his races 14 and picked the winners 16, the player visits a teller window at the racetrack and wagers 18 a desired amount of money for the Pick 5. Typically, the player communicates with the teller verbally. However, in Pick games, the player's bet is preferably recorded on a game card 44, such as is shown in FIG. 2. A typical game card 44 includes an area for the player or teller to mark how much money is being wagered 46, an area to indicate what races the player has selected for the Pick 5 48, and an area to indicate which horse or horses for the selected race the player believes will win. 50-68. For example, the player of the card 44 shown in FIG. 2 has wagered ten dollars on a Pick 5 game. The player has selected races 1, 4, 5, 7, and 10 in the race area 48. In race 1, the player believes horse 1 will win and a circle is darkened in the horse area 50 to indicate the player's selection. In race 2 the player believes the player's selections have been recorded in the appropriate horse selection areas 50, 52, 58, 62 and 64 and the player's wager is complete. After wagering, the player can enjoy the races 20 and play more.

Here, the player has wagered that a certain horse will win the first race 22, a certain horse will win the fourth race 36, fifth 38, seventh 40 and tenth 42 races. If the player's selected winner actually wins 24 the first race 22, the player can relax and wait until the fourth race 36. However, if a player's selected winner does not win 26 the first race 22, the player may determine if there are still more than the Pick(n) number of races left 28. Since the player here is playing a Pick 5, if his horse did not win 26 the first race 22, there are still nine races left. The player can wager again and still try and select the winners of any five remaining races for the event.

If there are more than five races left 34, the player can review the remaining races 12, select five 14 new races to include in his Pick 5, select whom he believes will win 16 those races, place his wager 18 and continue to watch and enjoy the remaining races 20. This process can continue until there are fewer races left than the number of races required for the Pick(n) wager 30. In this case, the player can continue to participate in the Pick 5 game until betting has closed for the fifth to last race. After the fifth to last race, if the player's selected winner does not win the race 26, there are fewer than five races left 28, so the player can no longer place another bet 30 and the player will lose 32 the Pick 5 game.

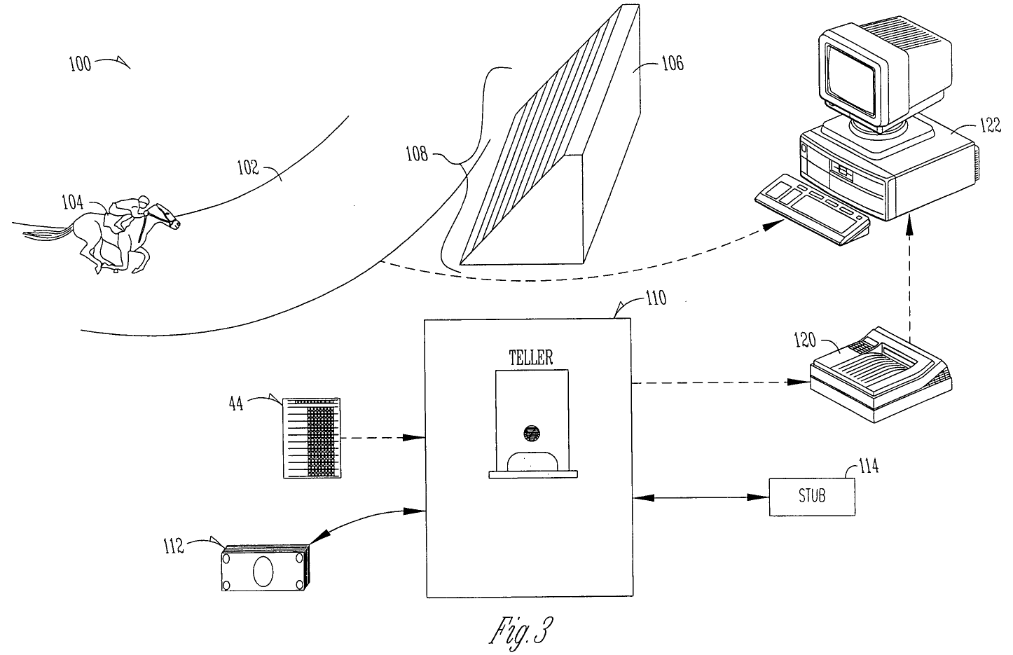

FIG. 3 shows a typical computer assisted way 100 to administer betting on a number of races within a racing event. Initially, all of the racing events are published, either electronically or in print form. In the Pick 5 scenario, the player selects a subset of five races to wager on and selects his predicted winners for each of these races. A player fills out a card 44 or simply tells the teller 110 what the player's wager is and deposits an amount of money 112. Preferably, the minimum wager amount is one dollar. In one embodiment of the invention, all of the players' wagers are collected together into a Pick 5 pool. The money put into the pool is divided up by all of the winners after the completion of the racing event, minus the published takeout.

The teller provides the player with a receipt or stub 114 to confirm the wager. From the teller, the wager is processed by a tote system. Typically, a tote system includes a betting terminal 120, computer 122, and other servers 124 along with the usual display and input devices and the software necessary to manage the system. Tote systems are commonly available today from such sources as United Tote and others. These systems process wagers and calculate and display odds and payoff information.

During the race 104, the fans can observe from the grandstands 108 or any other area in view of the racetrack 102. The race results are determined by the judges or stewards and entered into the mainframe 124. Once the results are made official, the finish order is entered into the computer 122. After completion of all of the event's races, the tote system calculates the winners of the Pick 5 wager by determining if one or more players have correctly selected each winner of the five races selected. Once the winners have been identified, they can return their ticket or stub 114 and collect their portion of the prize money.

For example, if thirty people have correctly selected the five winners of their five selected races, all thirty will split the money in the pool. If there is no winner, consolation prizes may be awarded according to the jurisdictional rules, for example, the Rules of the Iowa Racing & Gaming Commission.

A general description of the present invention as well as a preferred embodiment of the present invention has been set forth above. Those skilled in the art to which the present invention pertains will recognize and be able to practice additional variations in the methods and systems described which fall within the teachings of this invention. Accordingly, all such modifications and additions are deemed to be within the scope of the invention which is to be limited only by the claims appended hereto.

1. A method of gambling on horse races, the method comprising:
selecting a number for the quantity of an event's races to be included in a game;
allowing a player to chose which of an event's races the player wants to use for the number of races selected;
allowing the player to select the winners of the races the player has chosen; and
paying the player if the player's winners win the races the player has chosen.

2. The method of gambling on horse races of claim 1 wherein the number selected for the quantity of the event's races to be included in the game is less than the number of races in the event.

3. The method of gambling on horse races of claim 2 wherein the number is five.

4. The method of gambling on horse races of claim 1 wherein the player is paid if the player's winners win all of the races in the game.

5. The method of gambling on horse races of claim 1 wherein the player is paid if the player's winners win some of the races in the game.

6. A wager for betting on horse races, the wager comprising:
being informed that X number of races are to be included in the wager, where X is a number less than the total number of races in an event;
selecting which races in the racing event to use in the wager;
selecting the winners for X number of races in the event; and
placing a wager on the winners selected for the X number of races in the event.

7. The wager for betting on horse races of claim 6 wherein the X number of races are not run consecutively.

8. The wager for betting on horse races of claim 6 wherein the wager is for a minimum of one dollar.

9. A computer assisted method for administering betting on a plurality of races within a racing event using a computer for assistance, comprising:
publishing the racing event to a plurality of players for use in a betting wager;
receiving a selection of a subset of the plurality of races within the racing event from each of the plurality of players;
receiving a selection of a predicted winner for each race within the subset from the plurality of players;
receiving an amount of money associated with the selection of the subset of races and selection of predicted winners for each race within the subset from each of the plurality of players;
pooling at least a portion of each amount of money to form a pool;
receiving results from each race within the racing event;
identifying winners by determining if one or more players of the betting group correctly selected each winner for each race within the subset;
returning at least a portion of the money within the pool to one or more of the winners if one or more winners exist.

10. The computer assisted method of claim 9 wherein the selection of the subset of the plurality of races and the selection of predicted winners for each race within the subset is associated with a game card.

11. The computer assisted method of claim 10 wherein data on the game card is transferred to the computer.

12. The computer assisted method of claim 9 wherein the results of each race within the racing event are input into the computer.

13. The computer assisted method of claim 9 wherein at least one of the subsets of races is a subset of nonconsecutive races.
